(19) United States
(12) Patent Application Publication
(10) Pub. No.: US 2015/0215089 A1
(43) Pub. Date: Jul. 30, 2015

(54) METHOD AND APPARATUS FOR INTERFERENCE COORDINATION

(71) Applicant: Huawei Technologies Co., Ltd., Shenzhen (CN)

(72) Inventors: Zhiyu YAN, Beijing (CN); Lixia XUE, Beijing (CN)

(21) Appl. No.: 14/682,284

(22) Filed: Apr. 9, 2015

Related U.S. Application Data
(63) Continuation of application No. PCT/CN2012/082646, filed on Oct. 9, 2012.

(51) Int. Cl. H04L 5/00; H04L 1/18

(52) U.S. Cl. CPC H04L 5/0032; H04L 5/0073; H04L 1/1812; H04L 1/1893

(57) ABSTRACT

The present invention discloses a method and an apparatus. The present invention includes: generating enhanced-control-channel scheduling indication information, where the enhanced-control-channel scheduling indication information includes first scheduling indication information and/or second scheduling indication information, the first scheduling indication information is used for identifying a PRB corresponding to an interfered-with enhanced control channel in the cell, and the second scheduling indication information is used for indicating transmit power information corresponding to each PRB in the cell; and sending the enhanced-control-channel scheduling indication information to a neighboring cell, so that the neighboring cell determines, according to the enhanced-control-channel scheduling indication information, a PRB, of which a scheduling manner needs to be adjusted, in the neighboring cell. Embodiments of the present inversion are applied to a procedure for interference coordination between neighboring cells.

### CROSS-REFERENCE TO RELATED APPLICATIONS

This application is a continuation of International Patent Application No. PCT/CN2012/082646, filed on Oct. 9, 2012, which is hereby incorporated by reference in its entirety.

### TECHNICAL FIELD

The present invention relates to the field of communications technologies, and in particular, to a method and an apparatus for interference coordination.

### BACKGROUND

A heterogeneous network defined in 3GPP LTE-A standards indicates a network formed by cells that use different power, and these cells include macro base stations macro eNBs, Pico micro cells, and so on.

In this network architecture, a terminal user needs to correctly demodulate scheduling information from a cell, and generally, the scheduling information is carried on a control channel of the cell, that is to say, a user needs to correctly demodulate the control channel from the cell, so as to ensure data communication with the cell. In a heterogeneous network, because a low-power cell is introduced, an interference scenario in the heterogeneous network is complex; for example, transmit power of a macro base station Macro eNB is 46 dBm, and transmit power of a Pico cell is only 30 dBm. Apparently, because a transmit power difference between the macro base station and the Pico cell is large, a UE served by the Pico cell may be interfered with by the macro base station. Particularly, when range expansion (range expansion) is used as a cell selection criteria to expand a service range of the Pico cell, a user equipment served by the Pico cell is subject to stronger interference from the macro base station. In this case, an interference signal from the macro base station may be even stronger than a usable signal from the Pico cell.

Therefore, in order to ensure that a user equipment in a heterogeneous network works properly, it needs to be considered how to avoid interference between a PDSCH (physical downlink shared channel, physical downlink shared channel) and an enhanced control channel in cells of different power, and mutual interference between an enhanced control channel and an enhanced control channel, where the enhanced control channel may include an E-PDCCH (enhanced physical downlink control channel, enhanced physical downlink control channel) and/or an E-PHICH (Enhanced-Physical Hybrid ARQ Indicator Channel, enhanced-physical hybrid ARQ indicator channel), so as to guarantee that a user equipment served by an interfered-with cell can reliably receive the enhanced control channel.

### SUMMARY

Embodiments of the present invention provide a method and an apparatus for interference coordination, which can solve a problem that an enhanced control channel of a cell is interfered with by a neighboring cell, thereby ensuring performance of the enhanced control channel of each cell.

To achieve the foregoing objective, the embodiments of the present invention adopt the following technical solutions:

A method for interference coordination includes:

generating enhanced-control-channel scheduling indication information, where the enhanced-control-channel scheduling indication information includes first scheduling indication information and/or second scheduling indication information, the first scheduling indication information is used for identifying a PRB corresponding to an interfered-with enhanced control channel in a cell, and the second scheduling indication information is used for indicating transmit power information corresponding to each PRB in the cell; and

sending the enhanced-control-channel scheduling indication information to a neighboring cell, so that the neighboring cell determines, according to the enhanced-control-channel scheduling indication information, a PRB, of which a scheduling manner needs to be adjusted, in the neighboring cell,

where, the enhanced control channel includes an enhanced physical downlink control channel and/or an enhanced-physical hybrid ARQ indicator channel E-PHICH.

A method for interference coordination includes:

receiving enhanced-control-channel scheduling indication information sent by a neighboring cell, where the enhanced-control-channel scheduling indication information includes first scheduling indication information and/or second scheduling indication information, the first scheduling indication information is used for identifying a PRB corresponding to an interfered-with enhanced control channel in the neighboring cell, and the second scheduling indication information is used for indicating transmit power information corresponding to each PRB in the neighboring cell; and

determining, according to the enhanced-control-channel scheduling indication information, a PRB, of which a scheduling manner needs to be adjusted, in the neighboring cell,

where, the enhanced control channel includes an enhanced physical downlink control channel and/or an enhanced-physical hybrid ARQ indicator channel E-PHICH.

An apparatus for interference coordination includes:

a generating unit, configured to generate enhanced-control-channel scheduling indication information, where the enhanced-control-channel scheduling indication information includes first scheduling indication information and/or second scheduling indication information, the first scheduling indication information is used for identifying a PRB corresponding to an interfered-with enhanced control channel in the cell, and the second scheduling indication information is used for indicating transmit power information corresponding to each PRB in the cell; and

a sending unit, configured to send, to a neighboring cell, the enhanced-control-channel scheduling indication information generated by the generating unit, so that the neighboring cell determines, according to the enhanced-control-channel scheduling indication information, a PRB, of which a scheduling manner needs to be adjusted, in the neighboring cell,

where, the enhanced control channel includes an enhanced physical downlink control channel and/or an enhanced-physical hybrid ARQ indicator channel E-PHICH.

An apparatus for interference coordination includes:

a receiving unit, configured to receive enhanced-control-channel scheduling indication information sent by a neighboring cell, where the enhanced-control-channel scheduling indication information includes first scheduling indication information and/or second scheduling indication information, the first scheduling indication information is used for identifying a PRB corresponding to an interfered-with enhanced control channel in the neighboring cell, and the second scheduling indication information is used for indicating transmit power information corresponding to each PRB in the neighboring cell; and

a determining unit, configured to determine, from PRBs in a cell according to the enhanced-control-channel scheduling indication information, a PRB, of which a scheduling manner needs to be adjusted, in the neighboring cell,

where, the enhanced control channel includes an enhanced physical downlink control channel and/or an enhanced-physical hybrid ARQ indicator channel E-PHICH.

The embodiments of the present invention provide a method and an apparatus for interference coordination, where a cell sends enhanced-control-channel scheduling indication information to a neighboring cell, and the neighboring cell, after receiving the enhanced-control-channel scheduling indication information, adjusts scheduling of a PRB in the neighboring cell according to the enhanced-control-channel scheduling indication information, thereby avoiding a case where an enhanced control channel is strongly interfered with by a neighboring cell, solving an interference problem of enhanced control channels between cells, and ensuring performance of an enhanced control channel in an interfered-with cell.

### BRIEF DESCRIPTION OF DRAWINGS

To describe the technical solutions in the embodiments of the present invention more clearly, the following briefly introduces accompanying drawings required for describing the embodiments. Apparently, the accompanying drawings in the following description show merely some embodiments of the present invention, and a person of ordinary skill in the art may still derive other drawings according to these accompanying drawings without creative efforts.

FIG. 1 is a flowchart of a method for interference coordination according to Embodiment 1 of the present invention;

FIG. 2 is a flowchart of another method for interference coordination according to Embodiment 1 of the present invention;

FIG. 3 is a flowchart of a method for interference coordination according to Embodiment 2 of the present invention;

FIG. 4 is a flowchart of a method for interference coordination according to Embodiment 3 of the present invention;

FIG. 5 is a structural block diagram of an apparatus for interference coordination according to Embodiment 4 of the present invention;

FIG. 6 is a structural block diagram of another apparatus for interference coordination according to Embodiment 4 of the present invention;

FIG. 7 is a structural block diagram of another apparatus for interference coordination according to Embodiment 4 of the present invention;

FIG. 8 is a structural block diagram of another apparatus for interference coordination according to Embodiment 4 of the present invention;

FIG. 9 is a structural block diagram of another apparatus for interference coordination according to Embodiment 4 of the present invention;

FIG. 10 is a structural block diagram of another apparatus for interference coordination according to Embodiment 4 of the present invention;

FIG. 11 is a structural block diagram of another apparatus for interference coordination according to Embodiment 4 of the present invention;

FIG. 12 is a structural block diagram of an apparatus for interference coordination according to Embodiment 5 of the present invention; and

FIG. 13 is a structural block diagram of another apparatus for interference coordination according to Embodiment 5 of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

### Embodiment 1

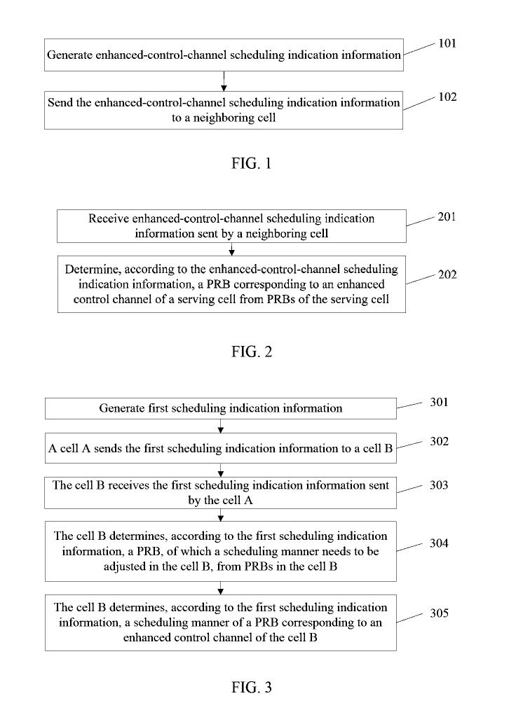

An embodiment of the present invention provides a method for interference coordination, and as shown in FIG. 1, the method includes:

101. Generate enhanced-control-channel scheduling indication information.

The enhanced-control-channel scheduling indication information includes first scheduling indication information and/or second scheduling indication information, where, the first scheduling indication information is used for identifying a PRB corresponding to an interfered-with enhanced control channel in the cell, and the second scheduling indication information is used for indicating transmit power information corresponding to each PRB in the cell.

A minimum unit of LTE radio resource allocation is a physical resource block (PRB, physical resource block), and one PRB includes 12 sub-carriers that are adjacent in a frequency domain.

The first scheduling indication information may specifically include identification information of the PRB corresponding to the interfered-with enhanced control channel in the cell, for example, information having an identification function, such as a block number of the PRB. Further, for ease of adjustment on a PRB scheduling manner of a neighboring cell by the neighboring cell, the first scheduling indication information may also include a scheduling manner of each PRB, for example, transmit power of a PRB, and a transmit direction of the enhanced control channel that schedules the PRB, and other information.

It should be noted that, in the embodiment, the described PRB corresponding to the interfered-with enhanced control channel is a PRB corresponding to an enhanced control channel that has been currently interfered with by the neighboring cell in the cell, and a PRB corresponding to an enhanced control channel that may be interfered with by a neighboring cell after a period of time when reference is made to a current cell status.

The second scheduling indication information may include a relative narrowband transmit power value corresponding to each PRB in the cell and a relative narrowband transmit power threshold.

The enhanced control channel includes an E-PDCCH (enchanted physical downlink control channel, enhanced physical downlink control channel) and/or an E-PHICH (Enhanced-Physical Hybrid ARQ Indicator Channel, enhanced-physical hybrid ARQ indicator channel).

102. Send the enhanced-control-channel scheduling indication information to the neighboring cell, so that the neighboring cell determines, according to the enhanced-control-channel scheduling indication information, a PRB, of which a scheduling manner needs to be adjusted, in the neighboring cell.

The sending enhanced-control-channel scheduling indication information to the neighboring cell may be implemented by using the following two methods, including:

a first method: directly sending the enhanced-control-channel scheduling indication information to the neighboring cell; and

a second method: sending the enhanced-control-channel scheduling indication information to an OAM (Operation, Administration and Maintenance, operation, administration and maintenance), so that the OAM, when receiving the enhanced-control-channel scheduling indication information, forwards the enhanced-control-channel scheduling indication information to the neighboring cell.

In the first method, the sending the enhanced-control-channel scheduling indication information to the neighboring cell may use a type of information, such as load indication information between base stations, for transmission.

In the second method, when the OAM performs forwarding, interaction between the cell and the OAM may use a type of message, such as a configuration message of a base station from an OAM, for transmission.

An embodiment of the present invention further provides a method for interference coordination, and as shown in FIG. 2, the method includes:

201. Receive enhanced-control-channel scheduling indication information sent by a neighboring cell, where the enhanced-control-channel scheduling indication information includes first scheduling indication information and/or second scheduling indication information.

The first scheduling indication information is used for identifying a PRB corresponding to an interfered-with enhanced control channel in the neighboring cell, and the second scheduling indication information is used for indicating transmit power information corresponding to each PRB in the neighboring cell. A detailed description is the same as the related description in step 102.

The enhanced control channel includes an E-PDCCH (enchanted physical downlink control channel, enhanced physical downlink control channel) and/or an E-PHICH (Enhanced-Physical Hybrid ARQ Indicator Channel, enhanced-physical hybrid ARQ indicator channel).

It should be noted that the received enhanced-control-channel scheduling indication information sent by the neighboring cell may be directly sent by the neighboring cell and may also be sent to the OAM by the neighboring cell and then be forwarded.

202. Determine, according to the enhanced-control-channel scheduling indication information, a PRB, of which a scheduling manner needs to be adjusted, in the neighboring cell.

The embodiment of the present invention provides a method for interference coordination, where a cell sends enhanced-control-channel scheduling indication information to a neighboring cell, and the neighboring cell, after receiving the enhanced-control-channel scheduling indication information, adjusts scheduling of a PRB in the neighboring cell according to the enhanced-control-channel scheduling indication information, thereby avoiding a case where an enhanced control channel is strongly interfered with by a neighboring cell, solving a problem that an enhanced control channel is strongly interfered with by a neighboring cell, and ensuring performance of an enhanced control channel of each cell.

### Embodiment 2

An embodiment of the present invention provides a method for interference coordination, which may be applied to a heterogeneous network defined in 3GPP LTE-A. In this embodiment, a cell A and a cell B, which belong to different base stations in the heterogeneous network but are adjacent spatially, are used as an example to describe a procedure for interference coordination in detail, which, as shown in FIG. 3, specifically includes the following steps:

301. A cell A generates first scheduling indication information.

The first scheduling indication information is used to identify a PRB corresponding to an interfered-with enhanced control channel in the cell A.

The generating the first scheduling indication information may be implemented by using the following method, which specifically is:

detecting whether interference exists on an enhanced control channel currently scheduled to a user equipment; if it is detected that the interference exists on the enhanced control channel currently scheduled to the user equipment, determining, from PRBs in the cell, a PRB corresponding to the enhanced control channel in which the interference exists; and generating the first scheduling indication information according to the determined PRB corresponding to the enhanced control channel in which the interference exists. Detecting whether interference exists on an enhanced control channel may be implemented by using a method, such as power comparison and detection of a success rate of information reception, which is not limited by the embodiment of the present invention.

In this embodiment, at the time of detecting whether interference exists on an enhanced control channel currently scheduled to a user equipment, if it is detected that the enhanced control channel currently scheduled to the user equipment has been interfered with by a neighboring cell, it is determined that the interference exists on the enhanced control channel, and if it is detected that some PRBs will be used for scheduling the enhanced control channel after a period of time and these PRBs will be interfered with by the neighboring cell according to a current cell signal status, it is also determined that the interference exists on the enhanced control channel.

The implementation method for generating the first scheduling indication information according to the determined PRB corresponding to the enhanced control channel in which the interference exists may be as follows: Process, in a manner of a bit map or joint coding, identification information of the PRB corresponding to the enhanced control channel in which the interference exists, and generate the first scheduling indication information.

It should be noted that, in the cell A, if there are both a PRB corresponding to an interfered-with E-PDCCH and a PRB corresponding to an interfered-with E-PHICH, the cell A needs to respectively generate, according to the PRBs respectively corresponding to the interfered-with E-PDCCH and the interfered-with E-PHICH, the first scheduling indication information and respectively send the first scheduling indication information to the neighboring cell. Alternatively, according to PRBs respectively corresponding to two different enhanced control channels, the cell A together generate a same piece of first scheduling indication information and use other additional indication information to distinguish the PRB corresponding to the interfered-with E-PDCCH from the PRB corresponding to the interfered-with E-PHICH in the same first scheduling indication information.

302. The cell A sends the first scheduling indication information to a cell B.

303. The cell B receives the first scheduling indication information sent by the cell A.

304. The cell B determines, according to the first scheduling indication information, a PRB, of which a scheduling manner needs to be adjusted in the cell B, from PRBs in the cell B.

The determining, according to the first scheduling indication information, a PRB, of which a scheduling manner needs to be adjusted in the cell B, may be implemented by using the following method, which includes:

determining, according to the first scheduling indication information, a PRB corresponding to an interfered-with enhanced control channel in the cell A; and

determining, from PRBs in the cell B, a PRB that uses a same scheduling resource as the PRB corresponding to the interfered-with enhanced control channel in the cell A, as the PRB, of which the scheduling manner needs to be adjusted in the cell B.

If a configuration of the cell A is the same as that of the cell B, the number of PRBs in the cell A is the same as that in the cell B. Then, during a process of determining a PRB that uses a same scheduling resource as the PRB corresponding to the interfered-with enhanced control channel in the cell A as a PRB corresponding to an enhanced control channel in the cell B, determine, directly in the cell B, a PRB, which has a same block number as the PRB corresponding to the interfered-with enhanced control channel in the cell A, as the PRB corresponding to the enhanced control channel in the cell B.

If the configuration of the cell A is different from that of the cell B, the cell B still needs to obtain resource allocation information of the PRB in the cell A, so as to determine indication information of the PRB, which uses the same scheduling resource, as the PRB corresponding to the interfered-with enhanced control channel in the cell A.

305. The cell B determines, according to the first scheduling indication information, a scheduling manner of the PRB corresponding to the enhanced control channel of the cell B.

The scheduling manner may include, but is not limited to, a manner that the cell B transmits a PRB by using low power, transmits a PRB by using zero power, or transmits a PRB by using a spatial resource which is spatially orthogonal to a transmit direction of an enhanced control channel of the cell A.

In addition, it should be noted that the embodiment of the present invention only uses an example of two cells in a heterogeneous network defined in 3GPP LTE-A for description; however, the technical solution provided in the present invention is not limited to the use in this network scenario only.

The embodiment of the present invention provides a method for interference coordination, where a cell sends enhanced-control-channel scheduling indication information to a neighboring cell, and the neighboring cell, after receiving the enhanced-control-channel scheduling indication information, adjusts scheduling of a PRB in the neighboring cell according to the enhanced-control-channel scheduling indication information, thereby avoiding a case where an enhanced control channel is strongly interfered with by a neighboring cell, and ensuring performance of an enhanced control channel of each cell.

### Embodiment 3

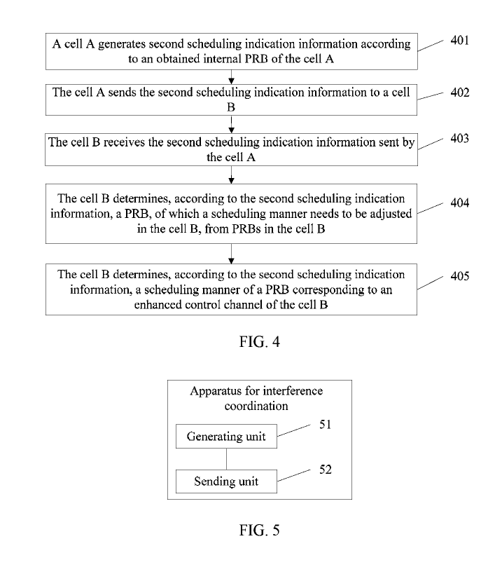

An embodiment of the present invention provides a method for interference coordination, which may be applied to a heterogeneous network defined in 3GPP LTE-A. In this embodiment, a cell A and a cell B, which belong to different base stations in the heterogeneous network but are adjacent spatially, are used as an example to describe a procedure for interference coordination in detail, which, as shown in FIG. 4, specifically includes the following steps:

401. A cell A generates second scheduling indication information.

The second scheduling indication information is used for indicating transmit power information corresponding to each PRB in the neighboring cell, which may specifically include a relative narrowband transmit power value corresponding to each PRB in the cell A and at least one relative narrowband transmit power threshold.

The generating the enhanced-control-channel scheduling indication information according to the obtained PRB in the cell A may be implemented by using the following method, which specifically is:

setting, according to a preset strategy, at least one relative narrowband transmit power threshold;

respectively generating, according to the at least one relative narrowband transmit power value, a relative narrowband transmit power value corresponding to each PRB; and

generating the second scheduling indication information according to the relative narrowband transmit power value corresponding to each PRB and the at least one relative narrowband transmit power threshold.

The preset strategy may include a value range of the relative narrow transmit power threshold, a performance requirement for receiving and sending a signal of a cell, and so on. For example, if the distance between the cell A and the cell B is large, a large threshold may be set; if the distance between the cell A and the cell B is small, a small threshold may be set, which is not limited by the embodiment of the present invention.

If only one relative narrowband transmit power threshold RNTP_{threshold}_{_{—}}₁ (RNTP_{threshold}_{_{—}}_{control}) is set, that the relative narrowband transmit power value corresponding to each PRB is respectively generated according to the RNTP_{threshold}_{_{—}}₁ (RNTP_{threshold}_{_{—}}_{control}) can be generated in a manner defined in Table 1.

TABLE 1
Definition of RNTP_1

| RNTP_2 | |
|---|---|
| 0 | Tx does not exceed RNTP_{threshold}_{_{—}}₁ (RNTP_{threshold}_{_{—}}_{control}) |
| 1 | No promise is made about Tx |

In Table 1, RNTP_{—}2 is a relative narrowband transmit power value of a PRB, and RNTP_{—}2 values of different PRBs need to be determined. Tx is a ratio of an EPRE (energy per resource element) of a PRB to an EPRE corresponding to maximum transmit power of an eNB, and the calculation method of Tx follows the following formula (1):

$$Tx = \frac{{E}_{A} ( {n}_{PRB} )}{{E}_{m a x \_ nom}^{( p )}} \qquad ( 1 )$$

where, E_{A}(n_{PRB}) is a maximum EPRE value to be used on a symbol other than an OFDM symbol carrying an RS (Reference signal) on the PRB in the cell, n_{PRB} is a physical resource block number, n_{PRB}=0, . . . , N_{RB}^{DL}−1, N_{RB}^{DL} is the number of PRBs within a downlink bandwidth,

$${E}_{m a x \_ nom}^{( p )} = \frac{{P}_{m ax}^{( p )} \cdot \frac{1}{Δ f}}{{N}_{RB}^{DL} \cdot {N}_{SC}^{RB}} , {N}_{SC}^{RB}$$

is the number of subcarriers in a PRB, Δf is a subcarrier width, and Pₘₐₓ^{(p)} is a maximum output power of a base station.

If multiple relative narrowband transmit power thresholds are set, and four thresholds are used as an example in this embodiment, that a relative narrowband transmit power value corresponding to each PRB is respectively generated according to the four set thresholds can be generated in a manner defined in table 2.

TABLE 2
Definition of RNTP_N

| RNTP_N | |
|---|---|
| 0 | The value of Tx is between RNTP_{threshold}_{_{—}}₁ and |
| | RNTP_{threshold}_{_{—}}₂ |
| 1 | The value of Tx is between RNTP_{threshold}_{_{—}}₂ and |
| | RNTP_{threshold}_{_{—}}₃ |
| 2 | The value of Tx is between RNTP_{threshold}_{_{—}}₃ and |
| | RNTP_{threshold}_{_{—}}₄ |
| 3 | No promise is made about Tx |

Tx is the same as the related description of Table 1, and RNTP_{threshold}_{_{—}}₁ to RNTP_{threshold}_{_{—}}₄ are four set thresholds, meeting RNTP_{threshold}_{_{—}}₁>RNTP_{threshold}_{_{—}}₂>RNTP_{threshold}_{_{—}}₃>RNTP_{threshold}_{_{—}}₄.

If more thresholds are set, the definition may be adaptively expanded according to the format of Table 1 and Table 2.

The second scheduling indication information may be transmitted in a format of IE of load information. For a specific representation method, see Table 3 and Table 4. Table 3 represents a format of the second scheduling indication information which is obtained when only one threshold is set in the cell A, and Table 4 represents a format of the second scheduling indication information which is obtained when four thresholds are set in the cell A.

TABLE 3
Format 1 of second scheduling indication information

| IE/Group | | | IE type and | Semantics | | Assigned |
|---|---|---|---|---|---|---|
| Name | Presence | Range | reference | description | Criticality | Criticality |
| RNTP_2 Per | M | | BIT STRING | Each position in the | — | — |
| PRB | | | (6 . . . 110, . . . ) | bitmap represents a | | |
| | | | | n_{PRB} value (i.e. first | | |
| | | | | bit = PRB 0 and so on), | | |
| | | | | for which the bit value | | |
| | | | | represents RNTP | | |
| | | | | (n_{PRB}) | | |
| RNTP_{threshold}_2 | M | | ENUMERATED | RNTP_{threshold}_2 is | — | — |
| | | | (−∞, | defined like Table-1 | | |
| | | | −19, −17, −15, −13, −11, | | | |
| | | | −10, −9, −8, −7, −6, −5, | | | |
| | | | −4, −3, −2, −1, 0, 1, 2, | | | |
| | | | 3, . . . ) | | | |

TABLE 4
Format 2 of second scheduling indication information

| IE/Group | | | IE type and | | | Assigned |
|---|---|---|---|---|---|---|
| Name | Presence | Range | reference | Semantics description | Criticality | Criticality |
| RNTP_N Per | M | | INTEGER (0 . . . 3) | Each position of the | — | — |
| PRB | | | | INTEGER represents a | | |
| | | | | n_{PRB} value (i.e. first | | |
| | | | | bit = PRB 0 and so on), | | |
| | | | | for which the | | |
| | | | | INTEGER value | | |
| | | | | represents RNTP (n_{PRB}), | | |
| | | | | defined in Table-2 | | |
| RNTP_{threshold}_1 | M | | ENUMERATED | RNTP_{threshold}_2 is | — | — |
| | | | (−∞, | defined in Table-1 | | |
| | | | −19, −17, −15, −13, −11, | | | |
| | | | −10, −9, −8, −7, −6, | | | |
| | | | −5, −4, −3, −2, −1, 0, | | | |
| | | | 1, 2, 3, . . . ) | | | |
| RNTP_{threshold}_2 | M | | ENUMERATED | defined as above | | |
| | | | (−∞, −21, | | | |
| | | | −19, −17, −15, −13, −11, | | | |
| | | | −10, −9, −8, −7, −6, | | | |
| | | | −5, −4, −3, −2, −1, 0, | | | |
| | | | 1, 2, 3, . . . ) | | | |
| RNTP_{threshold}_3 | M | | ENUMERATED | defined as above | | |
| | | | (−∞, −23, −21, | | | |
| | | | −19, −17, −15, −13, −11, | | | |
| | | | −10, −9, −8, −7, −6, | | | |
| | | | −5, −4, −3, −2, −1, 0, | | | |
| | | | 1, 2, 3, . . . ) | | | |
| RNTP_{threshold}_4 | M | | ENUMERATED | defined as above | | |
| | | | (−∞, −25, −23, −21, | | | |
| | | | −19, −17, −15, −13, −11, | | | |
| | | | −10, −9, −8, −7, −6, | | | |
| | | | −5, −4, −3, −2, −1, 0, | | | |
| | | | 1, 2, 3, . . . ) | | | |

It should be noted that content in Table 3 and Table 4 is merely an example, and in a case where there are more thresholds, content of the tables may be adaptively modified and added. A type and reference of information element may also adopt a manner of a bit map or joint coding or another form.

402. The cell A sends the second scheduling indication information to a cell B.

403. The cell B receives the second scheduling indication information sent by the neighboring cell.

404. The cell B determines, according to the second scheduling indication information, a PRB, of which a scheduling manner needs to be adjusted in the cell B, from PRBs in the cell B.

The determining, according to the second scheduling indication information, a PRB, of which a scheduling manner needs to be adjusted in the cell B, may be implemented by using the following method, which includes:

determining, according to the second scheduling indication information, a relative narrowband transmit power value corresponding to each PRB in the cell A and at least one relative narrowband transmit power threshold; performing calculation according to the relative narrowband transmit power value corresponding to each PRB in the cell A and the relative narrowband transmit power threshold of the cell A to estimate a transmit power value corresponding to each PRB in the cell A; and determining, according to preset anti-interference information and the transmit power value corresponding to each PRB in the cell A, a PRB corresponding to an enhanced control channel of the cell B, and determining the PRB corresponding to the enhanced control channel of the cell B as a PRB, of which a scheduling manner needs to be adjusted, in the cell B.

During an implementation process that at least one relative narrowband transmit power threshold is determined according to the second scheduling indication information, the number of determined relative narrowband transmit power thresholds depends on the number of relative narrowband transmit power thresholds carried in the second scheduling indication information. For example, the second scheduling indication information carries one relative narrowband transmit power threshold, and then the cell B must determine one relative narrowband transmit power threshold from the second scheduling indication information; if the second scheduling indication information carries four relative narrowband transmit power thresholds, the cell B must determine four relative narrowband transmit power thresholds from the second scheduling indication information.

The preset anti-interference information may include power thresholds that are set in the cell B for enhanced control channels carrying different control information, power thresholds that are set in the cell B for enhanced control channels covering users of different areas, and so on. The anti-interference information is specifically used to provide a selection rule for selecting a PRB corresponding to an enhanced control channel in the cell B. For example, two thresholds are set under a selection rule provided in the anti-interference information, and the cell B may allocate a PRB, of which the transmit power value exceeds a small power threshold but does not exceed a large power threshold, to an enhanced control channel with a low performance requirement, and allocate a PRB, of which the transmit power value does not exceed a small power threshold, to an enhanced control channel with a high performance requirement. If the enhanced control channel has two types of channels: an E-PDCCH and an E-PHICH, the cell B may allocate a PRB, of which the transmit power value exceeds a small power threshold but does not exceed a large power threshold, to the E-PDCCH, and allocate a PRB, of which the transmit power value does not exceed the small power threshold, to the E-PHICH. Definitely, the foregoing is only an example in this embodiment. A specific allocation method may be set according to an actual requirement.

405. The cell B adjusts a scheduling manner of a PRB in the cell B according to the second scheduling indication information.

Adjustment of a scheduling manner includes adjustment of enhanced control channels to which a PRB is to be allocated and adjustment of PRB transmit power for transmission, and so on.

In addition, it should be noted that Embodiment 2 and Embodiment 3 respectively aim at the enhanced-control-channel scheduling indication information being the first scheduling indication information and the enhanced-control-channel scheduling indication information being the second scheduling indication information. When the enhanced-control-channel scheduling indication information simultaneously includes the two types of scheduling information, a procedure to be executed may be implemented by executing steps 301 to 307 and steps 401 to 407 together.

In addition, it should be noted that a unit of enhanced-control-channel scheduling indication information described in the foregoing embodiment is PRB, but a corresponding solution procedure may also be applied to another scheduling unit granularity, for example, defining fixedly consecutive several PRBs as a PRB group, the corresponding solution procedure is consistent with a process described in the present invention.

In addition, it should be noted that, in the embodiment, the RNTP_{—}1, RNTP_N, RNTP_{threshold}_{_{—}}₁, RNTP_{threshold}_{_{—}}₂, RNTP_{threshold}_{_{—}}₃, and RNTP_{threshold}_{_{—}}₄, are all parameters used to indicate a signal condition of an enhanced control channel of each cell. These parameters may be used along with parameters used to indicate signal conditions of channels, such as a PDSCH and a PDCCH.

The embodiment of the present invention provides a method for interference coordination, where a cell sends enhanced-control-channel scheduling indication information to a neighboring cell, and the neighboring cell, after receiving the enhanced-control-channel scheduling indication information, adjusts scheduling of a PRB in the neighboring cell according to the enhanced-control-channel scheduling indication information, thereby avoiding a case where an enhanced control channel is strongly interfered with by a neighboring cell, and ensuring performance of an enhanced control channel of each cell.

### Embodiment 4

An embodiment of the present invention provides an apparatus for interference coordination, and as shown in FIG. 5, the apparatus includes: a generating unit 51 and a sending unit 52.

The generating unit 51 is configured to generate enhanced-control-channel scheduling indication information, where the enhanced-control-channel scheduling indication information includes first scheduling indication information and/or second scheduling indication information, the first scheduling indication information is used for identifying a PRB corresponding to an interfered-with enhanced control channel in the cell, and the second scheduling indication information is used for indicating transmit power information corresponding to each PRB in the cell.

The sending unit 51 is configured to send, to a neighboring cell, the enhanced-control-channel scheduling indication information generated by the generating unit 51, so that the neighboring cell determines, according to the enhanced-control-channel scheduling indication information, a PRB, of which a scheduling manner needs to be adjusted, in the neighboring cell.

The enhanced control channel includes an enhanced physical downlink control channel and/or an enhanced-physical hybrid ARQ indicator channel E-PHICH.

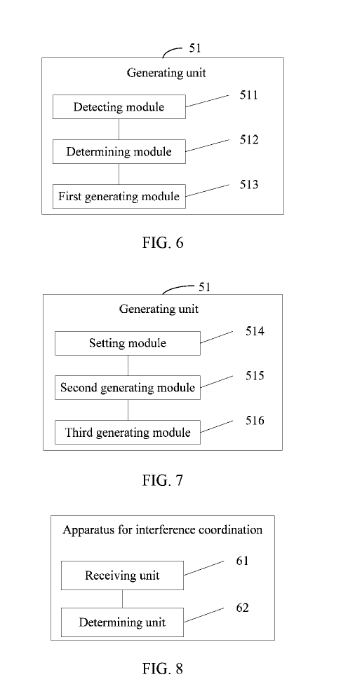

Optionally, as shown in FIG. 6, the generating unit 51 includes: a detecting module 511, a determining module 512, and a first generating module 513.

The detecting module 511 is configured to detect whether interference exists on an enhanced control channel currently scheduled to a user equipment when the enhanced-control-channel scheduling indication information is the first scheduling indication information.

The determining module 512 is configured to: when the detecting module 11 detects that the interference exists on the enhanced control channel currently scheduled to the user equipment, determine, from PRBs in the cell, a PRB corresponding to the enhanced control channel in which the interference exists.

The first generating module 513 is configured to generate the first scheduling indication information according to the PRB that is determined by the determining module 512 and corresponds to the enhanced control channel in which the interference exists.

Optionally, as shown in FIG. 7, the generating unit 51 includes: a setting module 514, a second generating module 515, and a third generating module 516.

The setting module 514 is configured to set, according to a preset strategy, at least one relative narrowband transmit power threshold when the enhanced-control-channel scheduling indication information is the second scheduling indication information.

The second generating module 515 is configured to respectively generate, according to the at least one relative narrowband transmit power threshold, a relative narrowband transmit power value corresponding to each PRB.

The third generating module 516 is configured to generate the second scheduling indication information according to the relative narrowband transmit power value corresponding to each PRB and the at least one relative narrowband transmit power threshold.

Optionally, the sending unit 51 is specifically configured to directly send the enhanced-control-channel scheduling indication information to the neighboring cell, and/or send the enhanced-control-channel scheduling indication information to an OAM, so that the OAM, when receiving the enhanced-control-channel scheduling indication information, forwards the enhanced-control-channel scheduling indication information to the neighboring cell.

An embodiment of the present invention provides another apparatus for interference coordination, which, as shown in FIG. 8, includes: a receiving unit 61 and a determining unit 62.

The receiving unit 61 is configured to receive enhanced-control-channel scheduling indication information sent by a neighboring cell, where the enhanced-control-channel scheduling indication information includes first scheduling indication information and/or second scheduling indication information, where the first scheduling indication information is used for identifying a PRB corresponding to an interfered-with enhanced control channel in the neighboring cell, and the second scheduling indication information is used for indicating transmit power information corresponding to each PRB in the neighboring cell.

The determining unit 62 is configured to determine, from PRBs in a cell according to the enhanced-control-channel scheduling indication information, a PRB, of which a scheduling manner needs to be adjusted, in the neighboring cell.

The enhanced control channel includes an enhanced physical downlink control channel and/or an enhanced-physical hybrid ARQ indicator channel E-PHICH.

Optionally, as shown in FIG. 9, the determining unit 62 includes: a first determining module 621 and a second determining unit 622.

The first determining module 621 is configured to: when the enhanced-control-channel scheduling indication information is the first scheduling indication information, determine a PRB corresponding to an interfered-with enhanced control channel in the neighboring cell according to the first scheduling indication information.

The second determining unit 622 is configured to determine, from PRBs in the cell B, a PRB that uses a same scheduling resource as the PRB corresponding to the interfered-with enhanced control channel in the neighboring cell, as a PRB corresponding to the enhanced control channel in the cell.

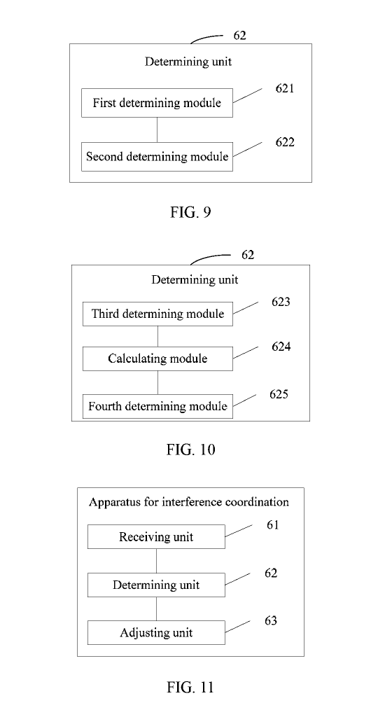

Optionally, as shown in FIG. 10, the determining unit 62 includes: a third determining module 623, a calculating module 624, and a fourth determining unit 625.

The third determining module 623 is configured to: when the enhanced-control-channel scheduling indication information is the second scheduling indication information, determine, according to the second scheduling indication information, a relative narrowband transmit power value corresponding to each PRB in the neighboring cell and at least one relative narrowband transmit power threshold in the neighboring cell;

The calculating module 624 is configured to perform calculation according to the relative narrowband transmit power value corresponding to each PRB in the neighboring cell and the at least one relative narrowband transmit power threshold in the neighboring cell to obtain a transmit power value corresponding to each PRB in the neighboring cell.

The fourth determining module 625 is configured to determine, according to preset anti-interference information and the transmit power value corresponding to each PRB in the neighboring cell, a PRB corresponding to an enhanced control channel of the cell, and determine the PRB corresponding to the enhanced control channel of the cell as a PRB, of which a scheduling manner needs to be adjusted, in the cell.

Optionally, as shown in FIG. 11, the apparatus further includes: an adjusting unit 63.

The adjusting unit 63 is configured to adjust the scheduling manner of the PRB in the cell according to the enhanced-control-channel scheduling indication information.

The embodiment of the present invention provides an apparatus for interference coordination, where a cell sends enhanced-control-channel scheduling indication information to a neighboring cell, and the neighboring cell, after receiving the enhanced-control-channel scheduling indication information, adjusts scheduling of a PRB in the neighboring cell according to the enhanced-control-channel scheduling indication information, so that PRB information of neighboring cells can be mutually considered between the neighboring cells to determine PRBs corresponding to enhanced control channels of the neighboring cells, thereby avoiding a case where an enhanced control channel is strongly interfered with by a neighboring cell, avoiding a case where an enhanced control channel is strongly interfered with by a neighboring cell, and ensuring performance of an enhanced control channel of each cell.

### Embodiment 5

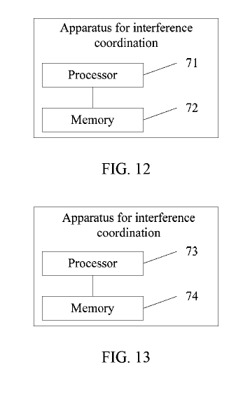

An embodiment of the present invention provides an apparatus for interference coordination, and as shown in FIG. 12, the apparatus includes: a processor 71 and a memory 72.

The processor 71 is configured to generate enhanced-control-channel scheduling indication information of an enhanced physical downlink control channel, where the enhanced-control-channel scheduling indication information includes first scheduling indication information and/or second scheduling indication information, the first scheduling indication information is used for identifying a PRB corresponding to an interfered-with enhanced control channel in the cell, and the second scheduling indication information is used for indicating transmit power information corresponding to each PRB in the cell; and send the enhanced-control-channel scheduling indication information to a neighboring cell, so that the neighboring cell determines, according to the enhanced-control-channel scheduling indication information, a PRB, of which a scheduling manner needs to be adjusted, in the neighboring cell

The enhanced control channel includes an enhanced physical downlink control channel and/or an enhanced-physical hybrid ARQ indicator channel E-PHICH.

The memory 72 is configured to store the enhanced-control-channel scheduling indication information.

The processor 71 is specifically configured to: when the enhanced-control-channel scheduling indication information is the first scheduling indication information, detect whether interference exists on an enhanced control channel currently scheduled to a user equipment; if it is detected that the interference exists on the enhanced control channel currently scheduled to the user equipment, determine, from PRBs in the cell, a PRB corresponding to the enhanced control channel in which the interference exists; and generate the first scheduling indication information according to the determined PRB corresponding to the enhanced control channel in which the interference exists.

The processor 71 is specifically further configured to: when the enhanced-control-channel scheduling indication information is the second scheduling indication information, set, according to a preset strategy, at least one relative narrowband transmit power threshold; respectively generate, according to the at least one relative narrowband transmit power threshold, a relative narrowband transmit power value corresponding to each PRB; and generate the second scheduling indication information according to the relative narrowband transmit power value corresponding to each PRB and the at least one relative narrowband transmit power threshold.

The memory 72 is further configured to store at least one relative narrowband transmit power threshold and a relative narrowband transmit power value corresponding to each PRB.

The processor 71 is specifically further configured to directly send the enhanced-control-channel scheduling indication information to the neighboring cell, and/or send the enhanced-control-channel scheduling indication information to an OAM, so that the OAM, when receiving the enhanced-control-channel scheduling indication information, forwards the enhanced-control-channel scheduling indication information to the neighboring cell.

An embodiment of the present invention provides an apparatus for interference coordination, and as shown in FIG. 13, the apparatus includes: a processor 73 and a memory 74.

The processor 73 is configured to receive enhanced-control-channel scheduling indication information sent by a neighboring cell, where the enhanced-control-channel scheduling indication information includes first scheduling indication information and/or second scheduling indication information, where the first scheduling indication information is used for identifying a PRB corresponding to an interfered-with enhanced control channel in the neighboring cell, and the second scheduling indication information is used for indicating transmit power information corresponding to each PRB in the neighboring cell; and determine, according to the enhanced-control-channel scheduling indication information, a PRB, of which a scheduling manner needs to be adjusted, in the neighboring cell. The enhanced control channel includes an enhanced physical downlink control channel and/or an enhanced-physical hybrid ARQ indicator channel E-PHICH.

The memory 74 is configured to store the enhanced-control-channel scheduling indication information.

The processor 73 is specifically configured to: when the enhanced-control-channel scheduling indication information is the first scheduling indication information, determine a PRB corresponding to an interfered-with enhanced control channel in the neighboring cell according to the first scheduling indication information; and determine, from PRBs in the cell B, a PRB that uses a same scheduling resource as the PRB corresponding to the interfered-with enhanced control channel in the neighboring cell, as a PRB corresponding to the enhanced control channel in the cell.

The memory 74 is configured to store the PRB corresponding to the interfered-with enhanced control channel in the neighboring cell.

The processor 73 is specifically configured to: when the enhanced-control-channel scheduling indication information is the second scheduling indication information, determine, according to the second scheduling indication information, a relative narrowband transmit power value corresponding to each PRB in the neighboring cell and at least one relative narrowband transmit power threshold; perform calculation according to the relative narrowband transmit power value corresponding to each PRB in the neighboring cell and the at least one relative narrowband transmit power threshold to obtain a transmit power value corresponding to each PRB in the neighboring cell; and determine, according to preset anti-interference information and the transmit power value corresponding to each PRB in the neighboring cell, a PRB corresponding to an enhanced control channel of the cell, and determine the PRB corresponding to the enhanced control channel of the cell as a PRB, of which a scheduling manner needs to be adjusted, in the cell.

The memory 74 is configured to store the relative narrowband transmit power value corresponding to each PRB in the neighboring cell, the at least one relative narrowband transmit power threshold, and the transmit power value corresponding to each PRB in the neighboring cell.

The processor 73 is further configured to adjust the scheduling manner of the PRB in the cell according to the enhanced-control-channel scheduling indication information.

The processor 73 is specifically further configured to directly send the enhanced-control-channel scheduling indication information to the neighboring cell, and/or send the enhanced-control-channel scheduling indication information to an OAM, so that the OAM, when receiving the enhanced-control-channel scheduling indication information, forwards the enhanced-control-channel scheduling indication information to the neighboring cell.

The embodiment of the present invention provides an apparatus for interference coordination, where a cell sends enhanced-control-channel scheduling indication information to a neighboring cell, and the neighboring cell, after receiving the enhanced-control-channel scheduling indication information, adjusts scheduling of a PRB in the neighboring cell according to the enhanced-control-channel scheduling indication information, so that PRB information of neighboring cells can be mutually considered between the neighboring cells to determine PRBs corresponding to enhanced control channels of the neighboring cells, thereby avoiding a case where an enhanced control channel is strongly interfered with by a neighboring cell, solving an interference problem of enhanced control channels between cells, and ensuring performance of an enhanced control channel of each cell.

Through the foregoing description of the embodiments, it is clear to a person skilled in the art that the present invention may be implemented by software plus necessary universal hardware, and definitely may also be implemented by hardware, but in many cases, the software implementation is preferred. Based on such an understanding, the technical solutions of the present invention essentially, or the part contributing to the prior art may be implemented in a form of a software product. The computer software product is stored in a readable storage medium, for example, a floppy disk, a hard disk, or an optical disc of a computer, and includes several instructions for instructing a computer device (which may be a personal computer, a server, or a network device, or the like) to perform the methods described in the embodiments of the present invention.

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

1. A method for interference coordination, comprising:
generating enhanced-control-channel scheduling indication information, wherein the enhanced-control-channel scheduling indication information comprises first scheduling indication information and/or second scheduling indication information, wherein the first scheduling indication information is used for identifying a physical resource block (PRB) corresponding to an interfered-with enhanced control channel in a cell, and the second scheduling indication information is used for indicating transmit power information corresponding to each PRB in the cell; and
sending the enhanced-control-channel scheduling indication information to a neighboring cell, to enable the neighboring cell to determine, according to the enhanced-control-channel scheduling indication information, a PRB, of which a scheduling manner needs to be adjusted, in the neighboring cell.

2. The method according to claim 1, wherein the enhanced control channel comprises an enhanced physical downlink control channel and/or an enhanced-physical hybrid ARQ indicator channel (E-PHICH).

3. The method according to claim 2, wherein when the enhanced-control-channel scheduling indication information is the first scheduling indication information, the generating the enhanced-control-channel scheduling indication information according to an obtained PRB in a cell comprises:
detecting whether interference exists on an enhanced control channel currently scheduled to a user equipment;
if it is detected that the interference exists on the enhanced control channel currently scheduled to the user equipment, determining, from PRBs in the cell, a PRB corresponding to the enhanced control channel in which the interference exists; and
generating the first scheduling indication information according to the determined PRB corresponding to the enhanced control channel in which the interference exists.

4. The method according to claim 2, wherein when the enhanced-control-channel scheduling indication information is the second scheduling indication information, the generating the enhanced-control-channel scheduling indication information according to an obtained PRB in a cell comprises:
setting, according to a preset strategy, at least one relative narrowband transmit power threshold;
respectively generating, according to the at least one relative narrowband transmit power threshold, a relative narrowband transmit power value corresponding to each PRB; and
generating, according to the relative narrowband transmit power value corresponding to each PRB and the at least one relative narrowband transmit power threshold, the second scheduling indication information.

5. The method according to claim 2, wherein the sending the enhanced-control-channel scheduling indication information to a neighboring cell comprises:
directly sending the enhanced-control-channel scheduling indication information to the neighboring cell; and/or
sending the enhanced-control-channel scheduling indication information to an operation administration maintenance (OAM), to enable the OAM, when receiving the enhanced-control-channel scheduling indication information, to forward the enhanced-control-channel scheduling indication information to the neighboring cell.

6. A method for interference coordination, comprising:
receiving enhanced-control-channel scheduling indication information sent by a neighboring cell, wherein the enhanced-control-channel scheduling indication information comprises first scheduling indication information and/or second scheduling indication information, the first scheduling indication information is used for identifying a physical resource block (PRB) corresponding to an interfered-with enhanced control channel in the neighboring cell, and the second scheduling indication information is used for indicating transmit power information corresponding to each PRB in the neighboring cell; and
determining, according to the enhanced-control-channel scheduling indication information, a PRB, of which a scheduling manner needs to be adjusted, in the neighboring cell.

7. The method according to claim 6, wherein the enhanced control channel comprises an enhanced physical downlink control channel and/or an enhanced-physical hybrid ARQ indicator channel (E-PHICH).

8. The method according to claim 7, wherein when the enhanced-control-channel scheduling indication information is the first scheduling indication information, the determining, according to the enhanced-control-channel scheduling indication information, a PRB corresponding to an enhanced control channel of the cell from PRBs in the cell comprises:
determining, according to the first scheduling indication information, a PRB corresponding to an interfered-with enhanced control channel in the neighboring cell; and
determining, from PRBs in the cell, a PRB that uses a same scheduling resource as the PRB corresponding to the interfered-with enhanced control channel in the neighboring cell, as a PRB corresponding to the enhanced control channel in the cell.

9. The method according to claim 7, wherein when the enhanced-control-channel scheduling indication information is the second scheduling indication information, the determining, according to the enhanced-control-channel scheduling indication information, a PRB corresponding to an enhanced control channel of the cell from PRBs in the cell comprises:
determining, according to the second scheduling indication information, a relative narrowband transmit power value corresponding to each PRB in the neighboring cell and determining, according to the second scheduling indication information, at least one relative narrowband transmit power threshold;
calculating according to the relative narrowband transmit power value corresponding to each PRB in the neighboring cell and the at least one relative narrowband transmit power threshold to obtain a transmit power value corresponding to each PRB in the neighboring cell; and
determining, according to preset anti-interference information and according to the transmit power value corresponding to each PRB in the neighboring cell, a PRB corresponding to an enhanced control channel of the cell, and determining the PRB corresponding to the enhanced control channel of the cell as a PRB, of which a scheduling manner needs to be adjusted, in the cell.

10. The method according to claim 8, wherein the determining, according to the enhanced-control-channel scheduling indication information, a PRB, of which a scheduling manner needs to be adjusted, in the neighboring cell further comprises:
adjusting the scheduling manner of the PRB in the cell according to the enhanced-control-channel scheduling indication information.

11. An apparatus for interference coordination, comprising:
a generating unit, configured to generate enhanced-control-channel scheduling indication information, wherein the enhanced-control-channel scheduling indication information comprises first scheduling indication information and/or second scheduling indication information, the first scheduling indication information is used for identifying a physical resource block (PRB) corresponding to an interfered-with enhanced control channel in a cell, and the second scheduling indication information is used for indicating transmit power information corresponding to each PRB in the cell; and
a sending unit, configured to send, to a neighboring cell, the enhanced-control-channel scheduling indication information generated by the generating unit, to enable the neighboring cell to determine, according to the enhanced-control-channel scheduling indication information, a PRB, of which a scheduling manner needs to be adjusted, in the neighboring cell.

12. The method according to claim 11, wherein the enhanced control channel comprises an enhanced physical downlink control channel and/or an enhanced-physical hybrid ARQ indicator channel (E-PHICH).

13. The apparatus according to claim 11, wherein the generating unit comprises:
a detecting module, configured to detect whether interference exists on an enhanced control channel currently scheduled to a user equipment when the enhanced-control-channel scheduling indication information is the first scheduling indication information;
a determining module, configured to: when the detecting module detects that the interference exists on the enhanced control channel currently scheduled to the user equipment, determine, from PRBs in the cell, a PRB corresponding to the enhanced control channel in which the interference exists; and
a generating module, configured to generate the first scheduling indication information according to the PRB that is determined by the determining module and corresponding to the enhanced control channel in which the interference exists.

14. The apparatus according to claim 11, wherein the generating unit comprises:
a setting module, configured to set, according to a preset strategy, at least one relative narrowband transmit power threshold when the enhanced-control-channel scheduling indication information is the second scheduling indication information;
a second generating module, configured to respectively generate, according to the at least one relative narrowband transmit power threshold, a relative narrowband transmit power value corresponding to each PRB; and
a third generating module, configured to generate the second scheduling indication information according to the relative narrowband transmit power value corresponding to each PRB and the at least one relative narrowband transmit power threshold.

15. The apparatus according to claim 11, wherein the sending unit is configured to directly send the enhanced-control-channel scheduling indication information to the neighboring cell, and/or send the enhanced-control-channel scheduling indication information to an operation administration maintenance (OAM), to enable the OAM, when receiving the enhanced-control-channel scheduling indication information, to forward the enhanced-control-channel scheduling indication information to the neighboring cell.

16. An apparatus for interference coordination, comprising:
a receiving unit, configured to receive enhanced-control-channel scheduling indication information sent by a neighboring cell, wherein the enhanced-control-channel scheduling indication information comprises first scheduling indication information and/or second scheduling indication information, the first scheduling indication information is used for identifying a physical resource block (PRB) corresponding to an interfered-with enhanced control channel in the neighboring cell, and the second scheduling indication information is used for indicating transmit power information corresponding to each PRB in the neighboring cell; and
an obtaining unit, configured to obtain a PRB in a cell; and
a determining unit, configured to determine, from PRBs in the cell according to the enhanced-control-channel scheduling indication information, a PRB, of which a scheduling manner needs to be adjusted, in the neighboring cell.

17. The method according to claim 16, wherein the enhanced control channel comprises an enhanced physical downlink control channel and/or an enhanced-physical hybrid ARQ indicator channel (E-PHICH).

18. The apparatus according to claim 17, wherein the determining unit comprises:
a first determining module, configured to: when the enhanced-control-channel scheduling indication information is the first scheduling indication information, determine a PRB corresponding to an interfered-with enhanced control channel in the neighboring cell according to the first scheduling indication information; and
a second determining unit, configured to determine, from PRBs in the cell, a PRB that uses a same scheduling resource as the PRB corresponding to the interfered-with enhanced control channel in the neighboring cell, as a PRB corresponding to the enhanced control channel in the cell.

19. The apparatus according to claim 17, wherein the determining unit comprises:
a third determining module, configured to: when the enhanced-control-channel scheduling indication information is the second scheduling indication information, determine, according to the second scheduling indication information, a relative narrowband transmit power value corresponding to each PRB in the neighboring cell and determining, according to the second scheduling indication information, at least one relative narrowband transmit power threshold in the neighboring cell;
a calculating module, configured to calculate according to the relative narrowband transmit power value corresponding to each PRB in the neighboring cell and the at least one relative narrowband transmit power threshold in the neighboring cell to obtain a transmit power value corresponding to each PRB in the neighboring cell; and
a fourth determining module, configured to: determine, according to preset anti-interference information and according to the transmit power value corresponding to each PRB in the neighboring cell, a PRB corresponding to an enhanced control channel of the cell, and determine the PRB corresponding to the enhanced control channel of the cell as a PRB, of which a scheduling manner needs to be adjusted, in the cell.

20. The apparatus according to claim 18, further comprising: an adjusting unit, configured to adjust the scheduling manner of the PRB in the cell according to the enhanced-control-channel scheduling indication information.
